(19) United States
(12) Patent Application Publication
(10) Pub. No.: US 2008/0260580 A1
(43) Pub. Date: Oct. 23, 2008

(54) Method and System for Radiopharmaceutical Kit Preparation

(75) Inventors: Kevin Helle, Bartlett, IL (US); James Pancy, Spring Lake, MI (US); Charles E. Shanks, Cary, IL (US)

Correspondence Address: GE HEALTHCARE, INC., IP DEPARTMENT, 101 CARNEGIE CENTER, PRINCETON, NJ, 08540-6231, US

(73) Assignee: MEDI-PHYSICS, INC., Princeton, NJ (US)

(21) Appl. No.: 12/092,157

(22) PCT Filed: Oct. 31, 2006
(86) PCT No.: PCT/US06/42714

§ 371 Date: Apr. 30, 2008

Related U.S. Application Data
(60) Provisional application No. 60/731,732, filed on Oct. 31, 2005.

(51) Int. Cl. B01L 9/00

(52) U.S. Cl. 422/63

(57) ABSTRACT

An automated system for remotely drawing and dispensing eluate in preparing kits of radioactive pharmaceuticals. The system includes cradles for holding shielded vials containing eluate or the final kit from cold kit vials. The present invention also provides methods and apparati directed to the withdrawal and dispensing of eluate while reducing waste and exposure to operators.

### FIELD OF THE INVENTION

The present invention relates to the field of radiopharmaceuticals. More specifically the present invention is directed to a method of preparing a radiopharmaceutical kit from which doses of radiopharmaceutical are drawn.

### BACKGROUND OF THE INVENTION

Pharmacies prepare thousands of Technetium (^{99m}Tc) kits daily and dispense millions of prescriptions annually. As a result of preparing these prescriptions the compounding pharmacists each receive between 10,000 mrem (100 mSv) and 30,000 mrem (300 mSv) annually in extremity dose based on ring dosimeter measurements. Pharmacy Operations and Pharmacy Regulatory Assurance have concluded that the majority of extremity exposure is associated with kit preparation. Pharmacy Operations anticipates that in order to be in keeping with ALARA (As Low As Reasonably Achievable) levels, it should continue to lower radiation dose limits (current company and regulatory limits are listed in Table 1). In addition, recent Nuclear Regulatory Commission (NRC) inspections throughout the industry have concentrated on the licensee's ability to demonstrate that the ring dosimeter accurately represents the dose to the maximally exposed area of the extremity (e.g., fingertips). As a result of these issues, it will be critical that Pharmacy Operations successfully implement a hands free kit preparation method and device, thereby allowing US pharmacies to continue to maintain employee doses ALARA and demonstrate that the use of the ring badge accurately reflects the dose to the maximally exposed area of the extremity.

TABLE 1
2003 Dose Limits

| | | | Pharmacy | | | | | |
|---|---|---|---|---|---|---|---|---|
| | | | Investigation | | Pharmacy | | | |
| | Regulatory Limit | | Level | | Control Level | | Pharmacy Limit | |
| Area | mrem/yr | mSv/yr | mrem/yr | mSv/yr | mrem/yr | mSv/yr | mrem/yr | mSv/yr |
| Whole Body | 5000 | 50 | 400 | 4 | 500 | 5 | 800 | 8 |
| Extremity* | 50000 | 500 | 20000 | 200 | 25000 | 250 | 27500 | 275 |

*NRC is using an extremity dose level of 25,000 mrem as a threshold beyond which the facility will have to demonstrate that they have assessed all extremity dose situations and determined that the dose reported by the ring badge accurately represents the dose to the maximally exposed area of the extremity. Regulators have stated that, if during an inspection it is noted that individuals are handling unshielded radioactive materials (such as not using a needle recapper) and any individual in the facility has an extremity dose exceeding 25,000 mrem, then the inspector may double the reported dose, which could result in an estimated overexposure to an individual's extremity.

Currently preparation of Technetium based kits is done by manually drawing the radioactive solution out of an eluate vial, and depositing the solution into multiple kits. It is the combination of the ^{99m}Tc, saline and the chemicals in the kit that form the active pharmaceutical that will be ultimately administered to the patient.

The current preparation process may result in excessive exposure and possible handling of unshielded radioactive material. FIG. 15 depicts the current method of Technetium kit preparation, which is a manually driven process requiring multiple assay steps to dispense the required activity of Technetium into the kits. This process can typically involve numerous Technetium eluate volumes for making numerous kits. Kits typically prepared include Myoview™ (or technetium Tc-99m tetrofosmin) sold by the assignee of the present invention, and numerous other Technetium based imaging agents. Manual processes for preparing the kits expose the pharmacist or technician, especially at their fingers and hands, to the uncontained radioactivity of the eluate.

The manual process of FIG. 15 is directed to providing an eluate of at least 500 mCi. In step M1, the pharmacist draws an aliquot of radioactive eluate into a 5 mL syringe with a syringe shield. In step M2 the pharmacist must place a cap on the needle, preferably using a capper device but free to do by manually inserting the cap over the syringe needle. In step M3, the pharmacist places the shielded syringe into a syringe stand and then when needed, uses tongs place the syringe into a dipper. In step M4 the pharmacist drops the dipper into a well and notes the activity of the contained aliquot. If at decision step M5 the pharmacist determines that the activity level has dropped below 500 mCi/mL, the operator will perform steps M6, M7 and M8 by removing the syringe from the dipper, placing the syringe on the needle stand and then, when ready, removing the syringe from the stand and removing the cap from the needle so that eluate may be added to or removed from the syringe prior to repeating steps M2-M5. At step M9 the pharmacist will decay the correct activity to the calibration time for usage of the final dose. At step M10 the pharmacist will calculate the saline needed to achieve the required concentration. At step M11 the pharmacist will insert a vent needle through the septum of the cold kit vial, push the required saline volume into the cold kit while being careful not to draw any fluid back into the saline syringe. At step M12 the pharmacist removes the syringe from the dipper, places the syringe into the needle shield in the shield stand. At step M13 the pharmacist uses the capper to remove the cap from the needle. At step M14 the pharmacist push the eluate into the cold kit vial and withdraw 5 ml of air. At step M15 the pharmacist uses tongs to remove the eluate syringe and vent needle from the now-prepared kit vial. Thereon the pharmacist at step M16 records the volume, time, eluation and activity at the time of fill on TKP. The pharmacist then performs step M17 by closing the slideable shield over the septum of the cold kit vial and removes the shielded kit from the laminar flow hood. At step M18 the pharmacist slowly inverts the kit vial 5 times in a row to ensure complete dissolution of the chemical powder provided in the cold kit vial. At step M19 the pharmacist places the kit vial on script labels on a table and waits at least 15 minutes before drawing a unit dose. The pharmacist would repeat these steps for as long as at least a 500 mCi eluate is available.

There are many instances during this process when the pharmacist may be exposed to radiation. It is also possible that the pharmacist may over fill the cold kit with eluate causing radioactive product to flow out the vent needle or even unseat the septum. When the pharmacist or technician must prepare many kits from one or more eluate vials, the cumulative risk and effect of even low level exposures are multiplied. There is therefore a need to reduce the potential for pharmacist and technician exposure by providing an automated system for preparing radioactive pharmaceutical kits.

Previous attempts to provide remotely operated drawing of radioactive compounds result in undesirable levels of wasted compound, which requires additional safe handling and disposal procedures as well as loss of valuable product. U.S. Pat. No. 5,039,863 describes an automated radioisotope filling apparatus in which a vial containing a radioisotope, a vial containing a saline solution, a drain vial, and a number of vials containing a label/drug are each connected via a network of valves and tubes so that the proper amounts of saline and radioisotope will be serially drawn through separate portions of the tube network into a single dispense syringe. From the dispense syringe the saline and radioisotope will each flow through a portion of the tube network so as to be dispensed into the label vials. The label vials are mounted to rotate about a transverse axis so as to stir and mix the contents of the label vial. Each of the vials are manually connected to the system by manually inserting the drain and vent needles into the vials. The radioisotope vial is taught to be mounted upside-down and the withdrawal needle is inserted well through, and perpendicularly to, the septum. The normal orientation of the needle and the septum (whereby the needle flow port extends some distance above the low septum floor) will result in some radioisotope not being drawn through the needle and dispensed to a label vial. The unused radioisotope is thus wasted and requires careful handling and disposal. Additionally, the disclosed network of tubing will retain some undispensed radioisotope which will also require careful handling, cleaning, and disposal of the tubing. Therefore, while providing a hands-free system for filling the radioisotope kits, the filling apparatus described still requires much operator interaction with radioactively dose intensive or radioactively contaminated components.

There is therefore a need for an improved hands-free device which will minimize operator exposure to radiation during both dispensing and cleaning/maintenance operations.

### SUMMARY OF THE INVENTION

In view of the needs of the prior art, the present invention provides a kit preparation system having a housing defining a preparation cavity. The housing is formed from a radiation-shielding material. The system also includes a syringe having an elongate hollow needle connected to a hollow syringe barrel supporting a syringe piston therein. The system further includes a syringe actuator for extending and retracting the syringe piston. The system also includes a vial holder for holding the pierceable septum for a vial in registry with the needle tip of the syringe and a translational mechanism for extending the needle tip through the septum of the vial.

The present invention also provides a cradle for holding a vial for holding radioactive contents. The cradle includes a cradle base, at least one upstanding wall supported on the cradle base, and a vial retention mechanism defining a vial cavity for accepting a vial. The retention mechanism releasably engages a vial in the vial cavity. The cradle also includes a crownpiece supported by the at least one upstanding wall to extend over the vial cavity. The crownpiece defines a first aperture therethrough in overlying registry with the vial cavity. In alternative embodiment of the present invention, the cradle includes a second aperture through the crownpiece so as to accommodate a vent or overflow needle which can extend through the septum without interfering with a needle inserted through the first aperture. In yet another embodiment of the present invention, the cradle includes a slanted geometry so as to hold an vial at an angle so as to present the lowest portion of the tilted-vial interior in registry with the first aperture so as to maximize the amount of fluid in the vial that may be withdrawn by a needle inserted through the first aperture.

The present invention yet further provides a method of withdrawing the contents from a vial with an automated fluid transfer device, wherein the vial defines an interior chamber and includes a planar base, an upstanding cylindrical wall and a pierceable septum about said interior chamber, and wherein the transfer device includes an elongate syringe supporting an elongate needle wherein said syringe and vial are linearly moveable with respect to each other so as to allow the needle to pierce a septum of the vial. The method includes the step of placing the vial into a vial holder which holds the vial in a slanted geometry with respect to the needle so that the needle may reach the lowest portion of the vial chamber as defined between the planar base and cylindrical wall.

The present invention even further provides a method of dispensing the contents of a syringe in an automated dispense system into a kit vial, wherein the kit vial defines an interior chamber and includes a planar base, an upstanding cylindrical wall and a pierceable septum about the interior chamber, wherein the transfer device includes an elongate syringe supporting an elongate needle wherein the syringe and vial are linearly moveable with respect to each other so as to allow the needle to pierce a septum of the vial. The method includes the steps of placing the vial, within its shield, into a vial holder; and inserting the tip of an elongate overflow needle through the vial holder into the vial chamber.

Thus, the present invention provides several benefits over the prior art. The present invention removes the need for manual manipulation of the vials, shields, or syringes during radioactive material fluid transfer. The present invention further reduces operator risk by reducing the internal the number and amount of fluid-handling components which require specialized handling, cleaning, and disposal when through with use. The present invention also provides the ability to precisely volumetrically dispense the required ^{99m}Tc into kits. Additionally, the present invention provides the ability to detect the type of vials, ie, eluate or kit (dispense) vials, are in place before initiating fluid transfer. Furthermore, the present invention provides shielding about an entire remotely-performed eluate transfer process. Also, the present invention provides overflow protection in case vial capacity is exceeded or other leakage occurs.

### BRIEF DESCRIPTION OF THE DRAWINGS

FIG. 1 depicts a general schematic of the components of a kit preparation system of the present invention.

FIG. 2 depicts a kit preparation system of the present invention.

FIG. 3 depicts a side elevational view of the syringe dispensing mechanism of the present invention.

FIG. 4 depicts the syringe dispensing mechanism of FIG. 3 mounted with the sensor mechanism for detecting the presence of the eluate cradle.

FIG. 5 depicts a side view of the syringe dispensing mechanism of FIG. 4.

FIG. 6 depicts an oblique elevational view of an eluate cradle assembly of the present invention.

FIG. 7 depicts another view of the eluate cradle assembly of FIG. 6.

FIG. 8 depicts the engagement between the eluate cradle assembly and a sensor mechanism of the syringe dispensing assembly.

FIG. 9 depicts an eluate cradle of the present invention holding a shielded vial from which a radioisotope may be drawn.

FIG. 10 depicts how an eluate cradle allows an inserted needle to extend to the lowest portion of the tilted vial being held.

FIG. 11 depicts an alternate view of the eluate cradle of FIG. 9.

FIG. 12 depicts an oblique elevational view of a dispense cradle assembly of the present invention.

FIG. 13 depicts another view of the dispense cradle assembly of the FIG. 12.

FIG. 14 depicts the sensor engagement means of the dispense cradle assembly of FIG. 12.

FIGS. 15-18 depict the vent needle assembly of the present invention.

FIG. 19 depicts the open drawer into which the eluate or fill cradles may be positioned so as to be slid into position below the syringe needle. A venting needle is inserted into the vial to collect any overflow of radioactive material into the dispense tube.

FIG. 20 is a top elevational view of a fill cradle holding a shielded kit vial and having the venting needle inserted. The evacuation tube from the venting needle is clearly seen.

FIG. 21 depicts a conveyor delivery line for positioning subsequent vials in underlying registry with the syringe of the present invention.

FIGS. 22A-B depict a prior art method for manually preparing a radioisotope kit.

FIGS. 23A-B depict the method for withdrawing eluate from a source vial to a syringe pump for preparing a radioisotope kit of the present invention.

FIGS. 24A-B depict the method for dispensing eluate into a kit vial from a syringe pump for preparing a radioisotope kit of the present invention.

### DETAILED DESCRIPTION OF THE INVENTION

The development of a hand free kit preparation method and device will reduce extremity exposure. The method and device of the present invention will enable the pharmacists to perform their functions without having to manually extract a volume of Technetium from an eluate vial, and then manually dispense that volume into a pharmaceutical kit vial.

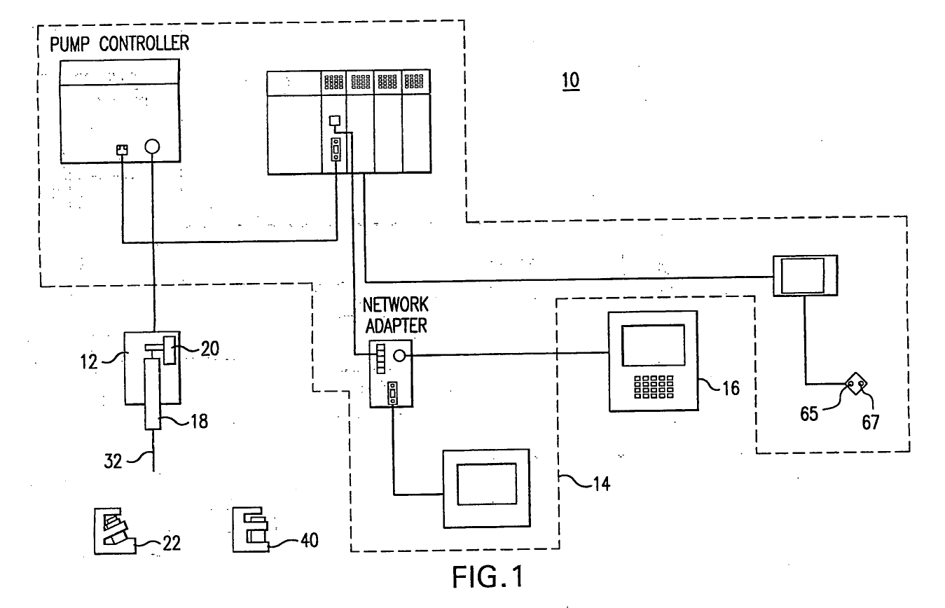

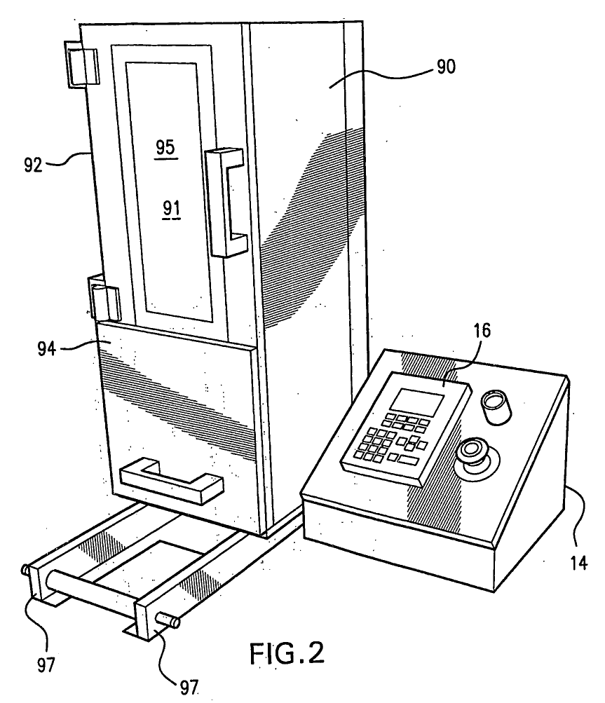

Referring now to FIGS. 1 and 2, the present invention provides a filling system 10 comprising syringe assembly 12, a computer controller 14, and an operator input/output display 16. Syringe assembly 12 includes an elongate syringe 18 operable by a syringe actuator 20 according to commands from the computer controller 14. A housing 85 is desirably formed from a radiation-shielding material and encloses syringe assembly 12. FIG. 1 is not depicted as an actual system but as a schematic layout, e.g, sensors 65 and 67 of the present invention are taught to be positioned in an area below needle 32.

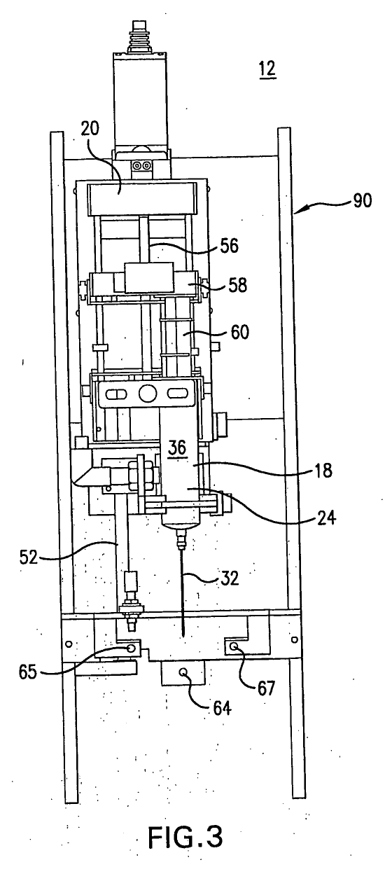

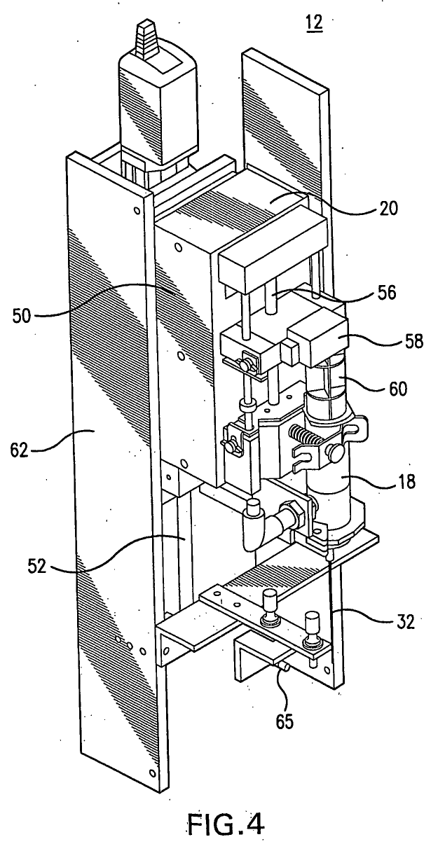

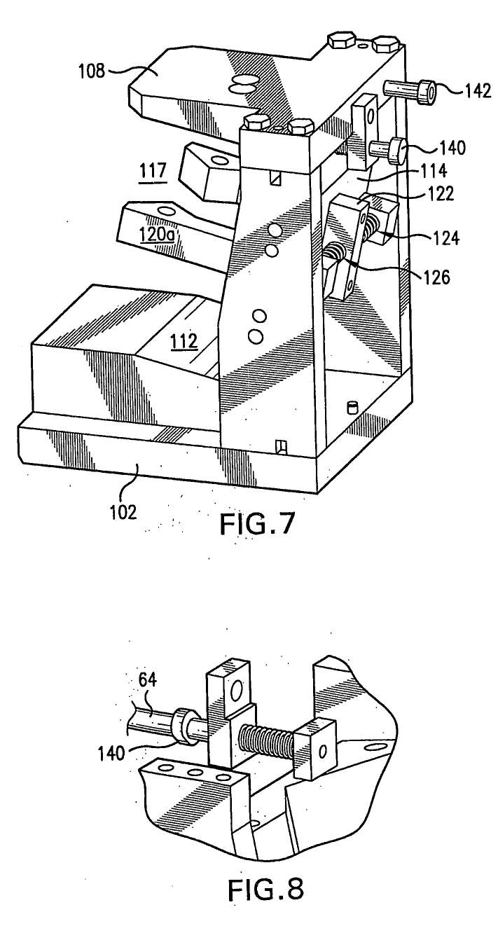

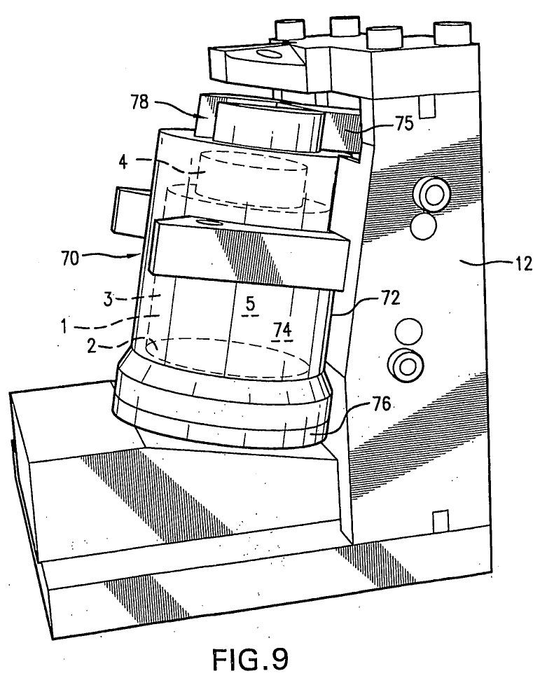

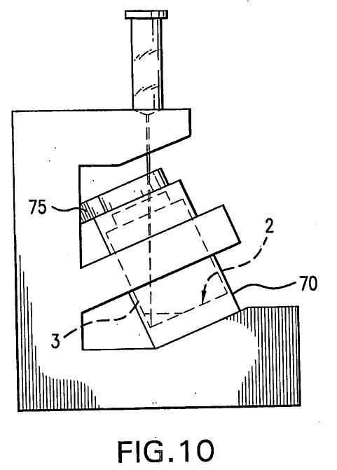

With additional reference to FIGS. 3-10, initially, an eluate cradle assembly 22, holding a shielded vial 1 of a radioisotope, is positioned in underlying registry with the needle 32 of syringe 18. Vial 1 and its components are shown in phantom lines in FIG. 9. Vial 1 is a typical vial formed from a suitable material for the fluid it is to hold and having a planar base surface 2 perimetrically bounded by an upstanding cylindrical wall 3 and sealed by a pierceable septum 4. Vial 1 includes an interior vial chamber 5 for storing a radioactive eluate such as ^{99m}Tc or a radio-labeled pharmaceutical product. Vial 1 is provided in a container 70 formed from a radiation-shielding material such as lead. Container 6 includes a cylindrical portion 72 defining a vial receptacle 74 closed by a planar base portion 76 threadably attached thereto. Cylindrical portion 72 defines an open access aperture 78 at an end opposite to base 76. A slideable radiation-shielding block 75 is movable between a closed position preventing access to aperture 78 and an open position allowing one or more needles to be inserted through aperture 78 and the septum 4 of an inserted vial 1. Container 70 is desirably inserted into cradle 22 so that the weight of block 75 causes it to slide downward clear of aperture 78.

Eluate cradle assembly 22 accommodates a vent needle to pierce the septum 4 of the kit vial 1 in a manner that will not interfere with the insertion and withdrawal of needle 32 through septum 4 of vial 1. The vent needle may include a filter which allows air to pass through but not liquid, or alternatively may include be connected to a flexible conduit for transporting away any liquid flowing out from vial 1 through the vent needle. Once eluate cradle assembly 22 is properly positioned such that a container 70 housing a vial 1 of eluate is in underlying registry with needle 32, syringe 18 is moved linearly downward to pierce septum 4. Cradle 22 holds the radioisotope vial at an angle so that needle 32 may be advanced to the lowest portion of the vial interior so as to maximize the amount of radioisotope withdrawn from the vial. The lowest portion is contemplated to mean about where planar surface 2 of vial 1 meets cylindrical wall 3 as the vial is held in the tilted position. The lowest portion of slanted vial chamber 5 is thus reachable by needle 32 as it is inserted through septum 4. By allowing needle 32 to reach this lowest portion of the tilted vial 1, the present invention increases the amount of eluate within vial chamber 5 which will be available for withdrawal and thereby minimizing waste of the eluate.

The barrel 24 of syringe 18 defines a container reservoir 36 for, desirably, holding sufficient volume of the radioisotope to fill multiple fill vials containing a drug to be labeled with the radioisotope. Once the radioisotope has been withdrawn from vial 1 into reservoir 36 of syringe 18, needle 32 and vial 1 will be linearly separated so that needle 32 is withdrawn clear of cradle 22. An operator may now replace eluate cradle 22 with a dispense cradle assembly 40 having a shielded vial which will be injected with eluate from syringe 18.

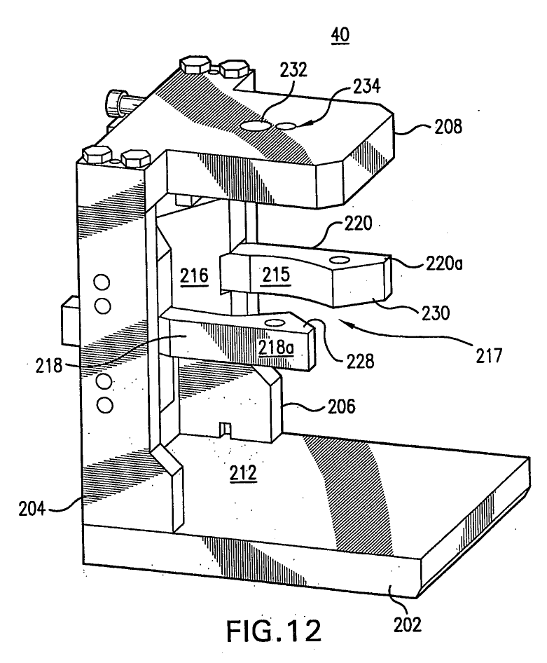

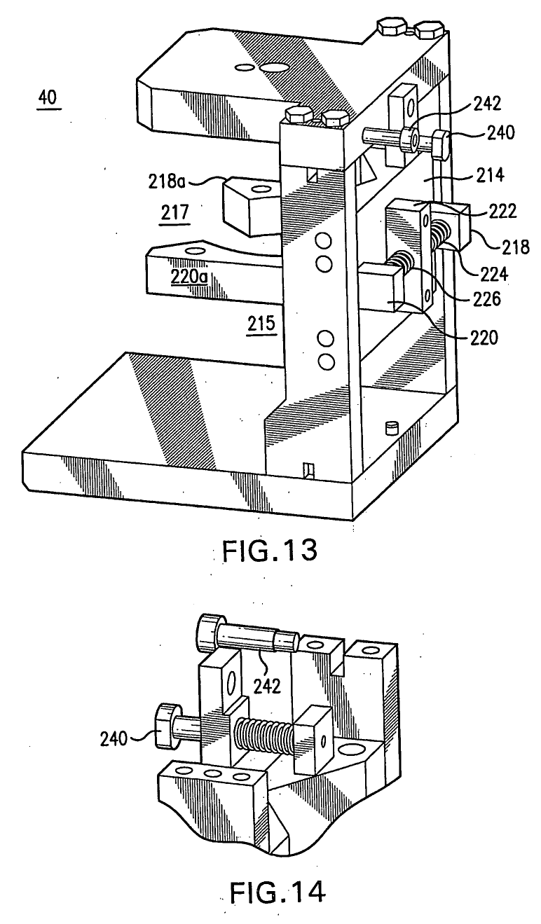

FIGS. 12-14 and 19-20 depict a dispense cradle assembly 40, holding a shielded kit vial 1. Kit vial 1 contains known amounts of saline solution and a drug to be labeled or mixed with the radioactive eluate. For the purposes of the present invention, kit vial 1 is of the same construction as, though possibly of different size than, vial 1 used to supply eluate to system 10. Similarly, kit vial 1 is provided in a shielded container 70′ which for the purposes of the present invention is of similar construction as container 70 described above, although it desirably exhibits a distinguishable ornamental appearance therefrom. The dispense cradle provides the kit vial upright, since the kit vial is only to be filled, not withdrawn to empty the vial. Dispense cradle assembly 40 accommodates a vent needle to pierce the septum 4 of the kit vial 1 in a manner that will not interfere with the insertion and withdrawal of needle 32 of syringe 18. The operator will enter the activity level required for the kit into computer controller 14 which will translate this input into the proper amount of radioisotope to be dispensed into the kit vial. The syringe 18 will be linearly translated downward enough for needle 32 to pierce through the septum of the kit vial by no more than 0.25 inches. The syringe actuator 20 will cause the proper amount of the radioisotope to be dispensed into the kit vial. Needle 32 is then withdrawn back through the septum of the kit vial so that dispense cradle 40 may be removed by the operator. The operator would then remove the shielded kit vial from cradle 40, possibly loading another unfilled shielded kit vial into cradle 40 for subsequent filling with the eluate.

The present invention therefore removes the need for manual manipulation of the vials, shields, or syringes during radioactive material fluid transfer. The present invention further reduces operator risk by reducing the internal the number and amount of fluid-handling components which require specialized handling, cleaning, and disposal when through with use, as only syringe 18 (and needle 32) receive the radioactive eluate. The control system provides the ability to precisely meter the required amounts of ^{99m}Tc into the kits. Additionally, the system 10 provides the ability to detect the type of vials, ie, eluate or kit (dispense) vials, are in place before initiating fluid transfer. Significantly, system 10 provides shielding about an entire remotely-performed eluate transfer process. Also, system 10 provides overflow protection in case vial capacity is exceeded or other leakage occurs.

Referring again to FIGS. 2-6, syringe 18 and actuator 20 are affixed to a first frame 50. Frame 50 is movably mounted to linearly translate in a vertical direction along an elongate vertically-extending guiderail 52. Actuator 20 includes a movable piston 56 and plunger-adaptor 58 affixed to piston 56. Actuator 20 reciprocally urges piston 56, and hence syringe plunger 60, to move in a vertical direction so as to control the uptake and dispensement of fluid through needle 32. Second frame 62 fixedly supports guiderail 52 so as to support the movement of frame 50 and, thus, syringe 18 and actuator 20.

Frame 62 supports radiation shield 90 mounted thereabout. Shield 90 includes a first access door 92 which is openable to allow operator access to syringe assembly 12 in the retracted, or raised, position. Shield 90 includes an access drawer 94 mounted below door 92 which is slideably openable along tracks 97 to allow operator access to the loading area for either eluate cradle 22 or fill cradle 40. Shield 90 is thereby designed to minimize operator exposure to radiation during use of the present invention.

FIGS. 1, 3-5 and 8 show that dispense system 10 includes sensor mechanism 64, 65, and 67 for detecting, and distinguishing, the presence of either eluate cradle 22 or dispense cradle 40. The sensor mechanisms 64, 65, and 67 include a button which is pressed when engaged by an associated prong projecting from a cradle. Sensor 64 determines that the cradle is properly positioned within drawer 90 while sensors 65 and 67 are only depressed by the identification prong 142 and 242 of the eluate cradle 22 and the dispense cradle 40, respectively. When a sensor is depressed by engaging its respective prong, a circuit is closed which generates a signal to the control system 14. The signals from sensors 65 and 67 serve to inform the control system of whether an eluate cradle or a dispense cradle have been inserted into system 10. The control system is programmed to notify the operator of the significance of such a signal being received and what options will be available for proceeding.

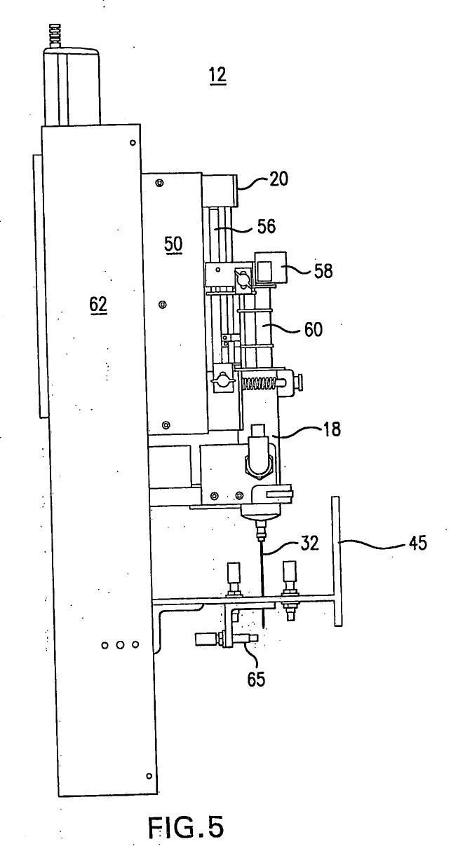

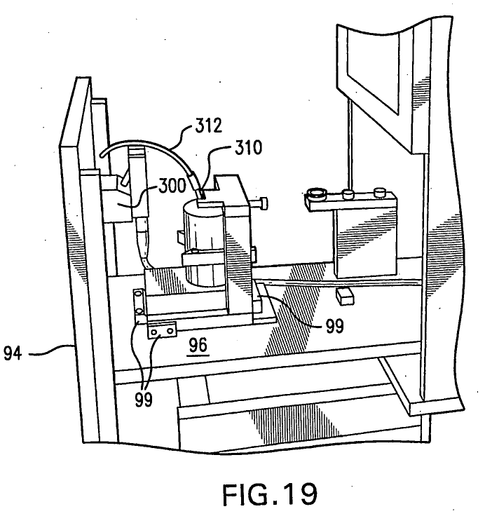

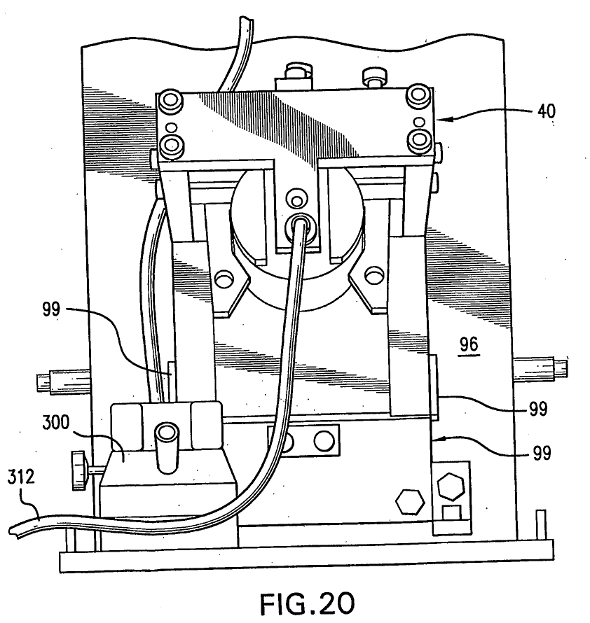

As shown in FIG. 2, syringe assembly 12 is desirably provided with an outer radiation housing 85 having a door 90 to access the syringe pump and a drawer 94 to allow the operator to insert and remove the cradles of the present invention to and from a position below needle 32. Shield 90 provides a first door 92 which allows access to a housing cavity 91 into which is positioned the syringe assembly 12. First door 92 further provides a window 95 to allow the operator to view syringe assembly 12 within housing cavity 91. Drawer 94 is mounted as a sliding drawer providing a base 96 for positioning the cradles 22 and 40 of the present invention. As shown in FIGS. 19 and 20, base 96 includes a number of chocks 99 affixed thereto which define a space between them into which either cradle 22 or cradle 40 may be inserted and held. The chocks 99 ensure the cradles maintain their position within drawer 92 as drawer 92 is slid closed and the respective identification lug and positioning prong engages their complimentary sensor of system 10. Additionally, as shown in FIG. 5, an inner radiation shield 45 may be supported about needle 32 in the retracted, or raised position, so as to further protect the operator while inserting and removing the cradles. Shield 45 desirably has a sufficient dimension to prevent or limit operator exposure to radiation emanating from needle 32 and syringe 18. It is further contemplated that syringe 18, including needle 32, may both be formed from a radiation-shielding material to obviate the need for shield 45.

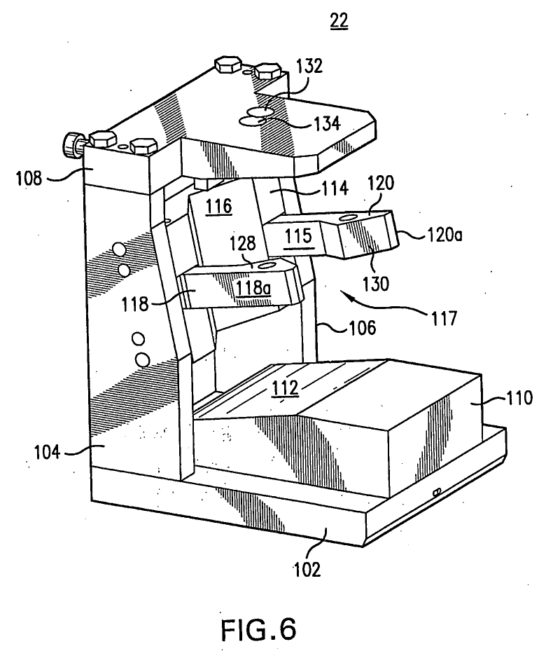

FIGS. 6-11 depict eluate cradle 22. Cradle 22 includes a base 102, first and second upstanding sidewalls 104 and 106, and a crownpiece 108. Base 102 supports a wedgepiece 110 having a planar support surface 112 sloped at an angle to base 102. A brace member 114 providing a V-shaped vial support surface 116 spans between sidewalls 104 and 106. Brace member 114 further hingedly supports first and second elongate brace arms 118 and 120. Brace arms 118 and 120 define a vial cavity 115 therebetween which receives a vial shield 70 therein. Each of brace arms 118 and 120 include a free end 118a and 120a, respectively, which define a vial-receiving opening 117 therebetween. Vial opening 117 is in fluid communication with vial cavity 115. Each of brace arms 118 and 120 further include second ends 118b and 120b, respectively, which are affixed by springs 124 and 126, respectively, to a bracket 122 mounted on brace member 114. The free ends 118a and 120a of arms 118 and 120 also support inward-facing detents 128 and 130 which serve to securely hold a shielded vial in place on surface 112. Springs 124 and 126 allow the free ends 118a and 120a of arms 118 and 120 to be urgeable away from each other as a shielded vial in inserted therepast towards support surface 116. Once the shielded vial is inserted past detents 128 and 130, arms 118 and 120 will close around the shielded vial to securely hold it in place.

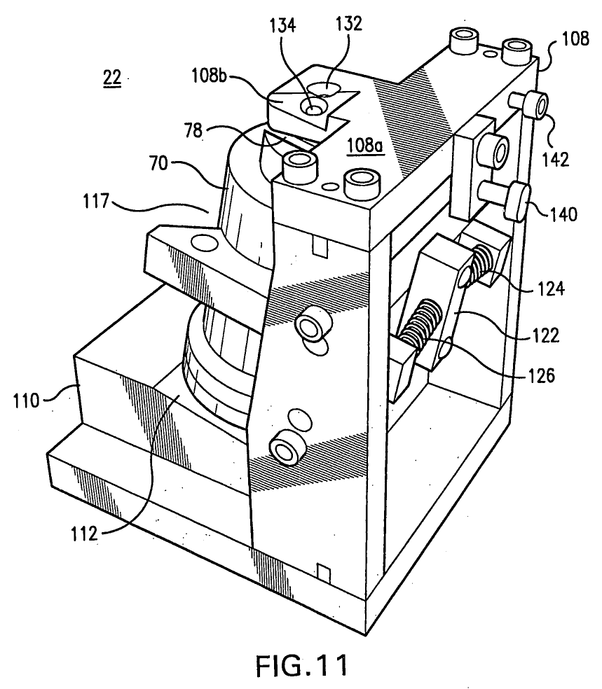

Crownpiece 108 defines a first and second through-hole 132 and 134, respectively, positioned to be in overlying registry with the septum of a vial held by cradle 22. Through-hole 132 extends normally through the opposing faces of crownpiece 108 so as to accommodate needle 18 being longitudinally extended therethrough so as to pierce through the septum of the vial and extend down to the lowest portion of the tilted vial and thereby be best positioned to withdraw all, or substantially all, of the contents of the vial. Through-hole 134 extends through the opposing faces of crownpiece 108 so as to accommodate an optional air-vent spike therethrough, not shown, which will allow airflow into the vial as the contents are withdrawn from the vial. Through holes 132 and 134 are formed to extend through crownpiece 108 in a manner which insures that needle 32 of syringe 18 inserted through through-hole 132 and a vent needle inserted through through-hole 134 will properly extend through the septum of the underlying vial without interfering with each other. Desirably, through-holes 132 and 134 extend along axes which are non-coplanar or non-parallel. As shown in FIG. 11, crownpiece 108 may include a top surface 108a defining one end of through-hole 132 and a second tapered surface 108b defining one end of through-hole 134. Provision of tapered surface 108b further ensures that the vent needle may be inserted in a direction substantially normal to the longitudinal axis of through-hole 134.

Crownpiece 108 further supports detection prong 140 which engages sensor 64 of syringe assembly 12 so as to notify the dispense system that the cradle has been inserted. Crownpiece 108 further supports an identification prong 142 which engages sensor 65 of syringe assembly 12 so as to indicate that the cradle supports a vial of radioisotope eluate. When cradle 22 is detected by the system, the system will know that needle 18 should be lowered to its fully-extended position to allow maximum withdrawal of the contents of the vial. FIG. 8 depicts the engagement between prong 140 of eluate cradle 22 and sensor mechanism 64 of kit syringe assembly 12.

FIGS. 12-14 and 19-20 depict features of dispense cradle assembly 40. Cradle 40 includes a base 202, first and second upstanding sidewalls 204 and 206, and a crownpiece 208. Base 202 provides a planar and horizontal support surface 212. A brace member 214 providing a V-shaped vial support surface 216 spans between sidewalls 204 and 206. Brace member 214 further hingedly supports first and second elongate brace arms 218 and 220. Brace arms 218 and 220 define a vial cavity 215 therebetween which receives a vial shield 70 therein. Each of brace arms 218 and 220 include a free end 218a and 220a, respectively, which define a vial-receiving opening 217 therebetween. Vial opening 217 is in fluid communication with vial cavity 215. Each of brace arms 218 and 220 further include second ends 218b and 220b, respectively, which are affixed by springs 224 and 226, respectively, to a bracket 222 mounted on brace member 214. The free ends 218a and 220a of arms 218 and 220 also support inward-facing detents 228 and 230 which serve to securely hold a shielded vial in place on surface 212. Springs 224 and 226 allow the free ends 218a and 220a of arms 218 and 220 to be urgeable away from each other as a shielded vial in inserted therepast towards support surface 216. Once the shielded vial is inserted past detents 228 and 230, arms 218 and 220 will close around the shielded vial to securely hold it in place.

Crownpiece 208 defines a first and second through-hole 232 and 234, respectively, positioned to be in overlying registry with the septum of a vial held by cradle 40. Through-hole 232 extends normally through the opposing faces of crownpiece 208 so as to accommodate needle 18 being longitudinally extended therethrough so as to pierce through the septum of the vial and extend into the container cavity of the vial. Through-hole 234 extends through the opposing faces of crownpiece 208 so as to accommodate a vent needle therethrough which will allow airflow from the vial as the eluate is added to the contents of the vial. The vent needle may also contain any fluid which might overflow from the vial due to the filling operation. Through holes 332 and 234 are formed to extend through crownpiece 208 in a manner which insures that needle 32 of syringe 18 inserted through through-hole 232 and a vent needle inserted through through-hole 234 will properly extend through the septum of the underlying vial without interfering with each other. Desirably, through-holes 232 and 234 extend along axes which are non-coplanar or non-parallel.

Crownpiece 208 further supports detection prong 240 which engages a sensor of syringe assembly 12 so as to notify the dispense system that the cradle has been inserted. Crownpiece 208 further supports an identification prong 242 which engages a sensor of syringe assembly 12 so as to indicate that the cradle supports a vial of radioisotope. When cradle 40 is detected by the system, the system will know that needle 18 should be lowered to an extended position which allows dispensement of the radioisotope into the vial. FIG. 14 depicts the detection and identification prongs 240 and 242 of dispense cradle 40.

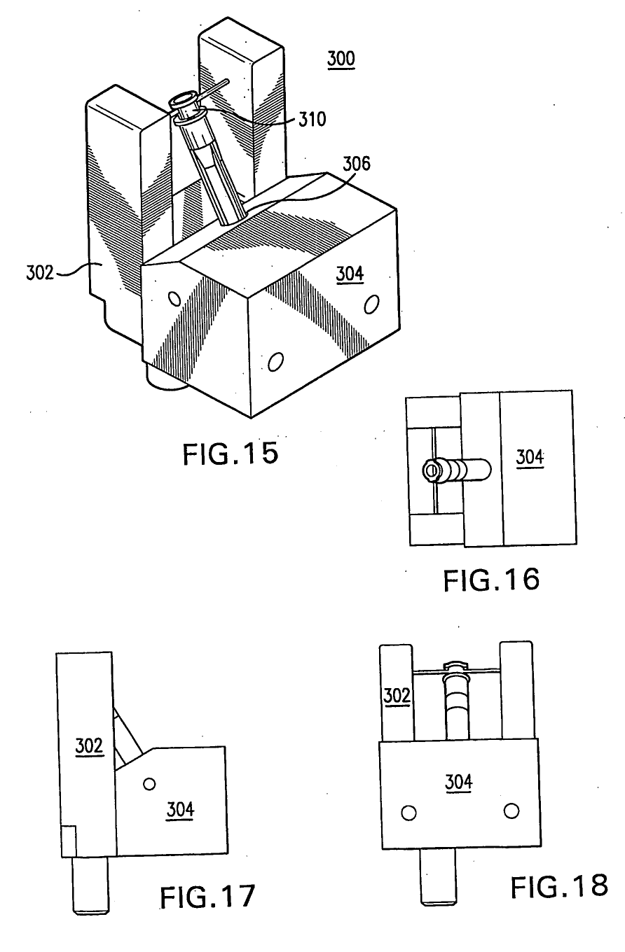

FIGS. 15-18 further depict the vent needle holder assembly 300 of the present invention. Holder assembly 300 is desirably formed of lead or any suitable radiation-shielding material. The back surface of door 94 supports holder assembly 300. As can be seen in FIGS. 19 and 20, the vent needle 310 is connected to a drain tube 312 for conducting away any overflow of the radioisotope provided to the fill vial, thus further reducing operator exposure in the event that too much fluid is provided to the vial.

Holder assembly 300 also provides a place to store a venting needle when not in use. Holder assembly 300 includes a mounting bracket 302 and a holder block 304. Holder block 304 defines an elongate storage receptacle 306 which is sized and shaped to receive a vent needle 310 while the vent needle is not in use.

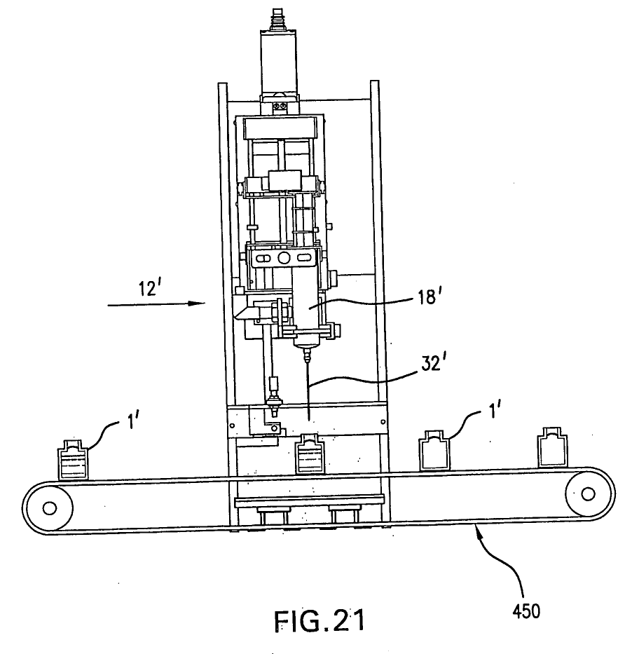

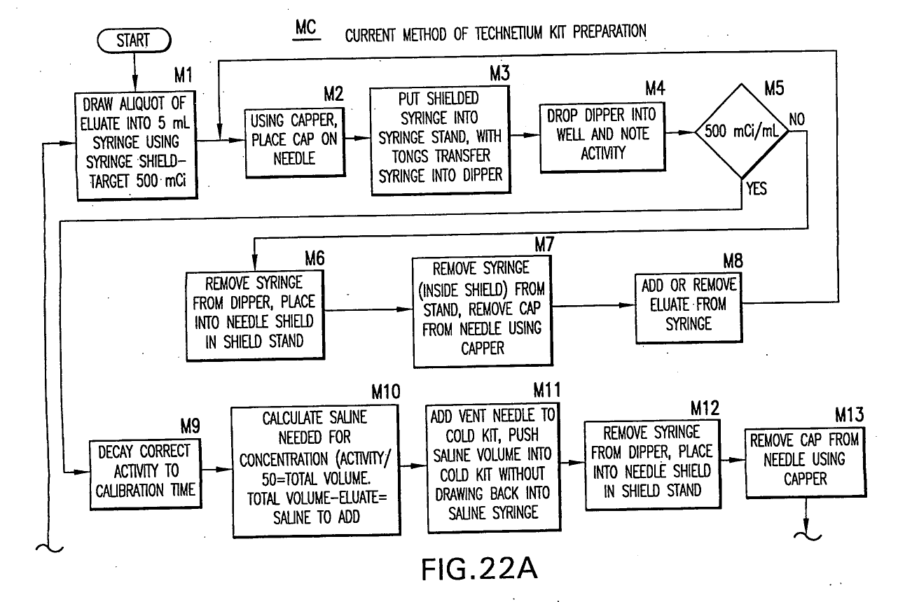

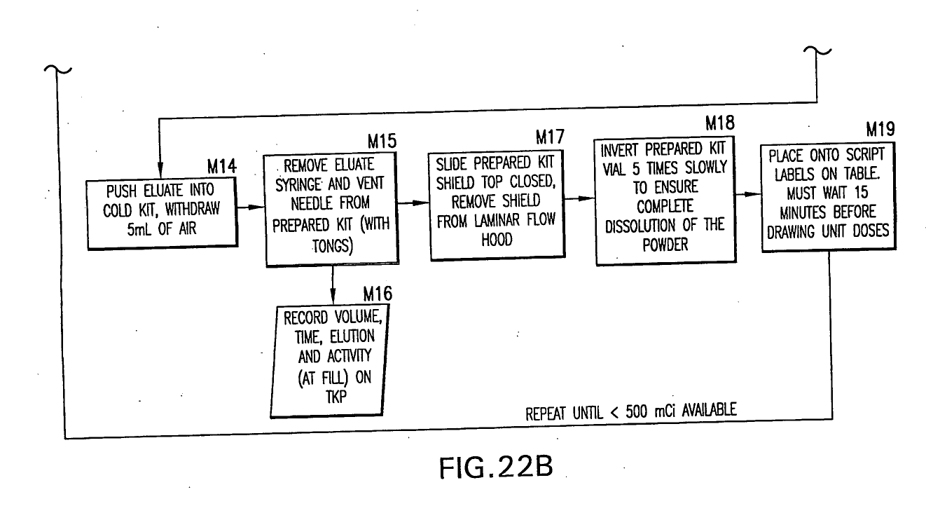

It is further contemplated by the present invention that an automated feed system may be provided to automatically position a series of fill cradles 40 under syringe 18 for filling. FIG. 21 depicts a modified dispense system 10′ in which lower drawer 90 is replaced with a conveyor belt assembly 450 positioned to run beneath needle 32 of syringe 18. Conveyor assembly 450 may thereby provide vials a progression of vials 1″ be filled or withdrawn from in seriatum. A control system could program this operation to take place remotely so as to minimize operator exposure to radioactive fluids.

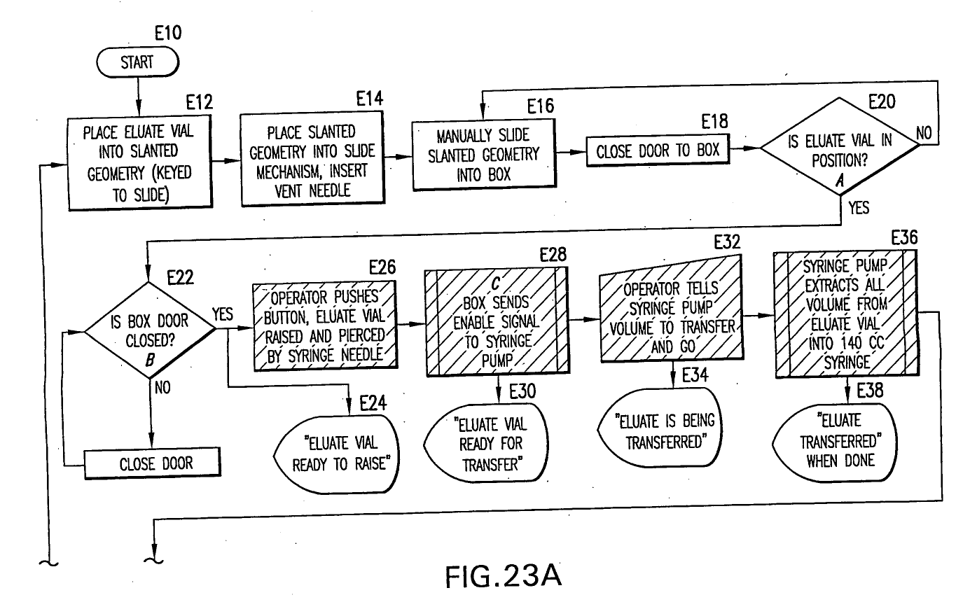

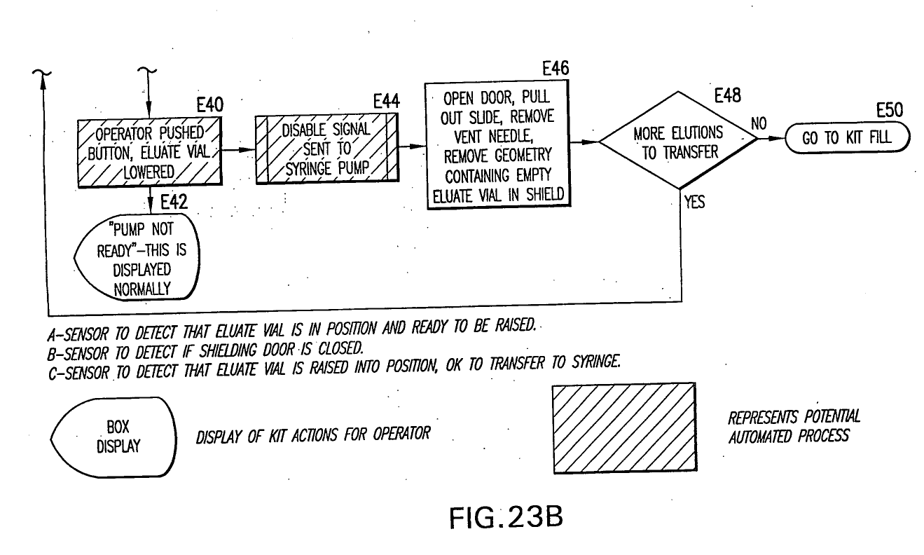

One method of preparing a radiopharmaceutical kit of the present invention is depicted in FIGS. 23A-B and 24-B and involves an intermediary step of combining multiple Technetium eluate volumes fluid into a bulk reservoir, assaying (for activity/volume), and then volumetrically dispensing into multiple kits.

The method E10 of transferring eluate of the present invention is provided in FIG. 23A-B and described as follows. In a first step, E12, a pharmacist or technician (hereinafter an “operator”) places an eluate vial, the vial itself within a shielded container, into a vial holder having a slanted geometry. Typically, the eluate vial will contain either 6 or 20 cc of Technetium-99, although it will be readily apparent that other amounts and types of eluate will be compatible with the present invention. In step E14 the operator places the vial holder into position in the sliding drawer of the filling and dispense system and removes the vent needle from its holster mounted in the sliding drawer and inserts it through the vent needle aperture in the vial holder so as to pierce the septum. It is contemplated by the present invention that the vent needle may itself be positioned at one end of a suitable conduit which is able to contain any leakage of eluate should the eluate flow therethrough, e.g., in the event of overpressure within the eluate vial. The vent conduit may further be connected to a vacuum device for drawing any eluate away from the vent needle or otherwise prevent the eluate from spilling out of the vent needle upon its withdrawal from the eluate vial. In step E16 the operator manually slides the drawer into a closed position, thereby placing the eluate vial under the syringe needle. In step E18 the operator closes the door to the filling and dispense system.

In step E20 the system desirably checks to ensure that the eluate vial is in position by detecting a device or signal unique to the vial holder for an eluate vial. If the system fails to detect that an eluate vial or vial holder is in the proper position, the operator will be notified. The operator may then access the drawer holding the eluate vial and ensure the vial holder is properly placed therein and repeat from step E16 to ensure the drawer is properly closed so that the vial is properly positioned within the system. In step E22 the system will also ensure that the door to the system is properly closed and signal the operator if is not so.

Once the door is properly closed, in step E24 the control system will indicate to the operator that the eluate vial is ready to raise. In step E26 the operator pushes the appropriate button (desirably through a graphic user interface display of the control system) to cause the system to cause the syringe needle of the system to pierce through the septum of the eluate vial. Desirably, as the eluate vial holder holds the eluate vial in a slanted geometry, the syringe needle may extend to the lowest portion of the vial chamber, e.g., where the planar base wall meets the upstanding cylindrical wall, so as to maximize the amount of eluate available for withdrawal and thereby minimize the amount of unused eluate remaining in the eluate vial. Desirably, the method of the present invention causes the piercing of the vial septum by raising the eluate vial holder towards the syringe needle, although the present invention contemplates that the syringe of the system is itself movably mounted to linearly extend through the vial septum in a similar manner as described for kit preparation system 10.

When the system detects that the syringe needle is properly positioned with respect to the eluate vial from step E26, the system in step E28 will enable the syringe pump and in step E30 indicate to the operator that the eluate vial is ready for transfer. In step E32 the operator will push the appropriate control system button, either hardwired or a soft switch provided by a graphical user interface, to commence fluid transfer of an operator-inputted volume of eluate from the eluate vial to the syringe. The system will, in step E34, indicate to the operator that eluate transfer is taking place. As identified in step E36, this operator action will cause the syringe piston to be drawn away from the syringe needle, thereby drawing the eluate from eluate vial into the syringe barrel. The control system will then signal to the operator, in step E38, when the eluate transfer is complete.

In step E40 the operator will then push the appropriate button to cause the separation of the syringe needle from the vial, again by lowering the vial holder, raising the needle, or some combination thereof. In step E42, the control system will display that the pump is not ready, indicating that separation from the needle and vial is attained. Desirably, an appropriate signal is sent to the syringe pump in step E44 to prevent additional withdrawal or dispensement by the syringe. In step E46 the operator would open the system door, pull out the drawer, remove the vent needle from the vial holder and insert it into its needle holster mounted inside the sliding drawer and remove the eluate vial holder. In step E48 the system would ask the operator whether additional eluate will be transferred from additional eluate vials. If so, the operator would then repeat this process from step E12 until sufficient eluate has been loaded into the syringe barrel for dispensement into the cold kits, when the method proceeds to step E50, or otherwise allows the operator to then go to the kit filling process.

While certain steps of the present invention have been discussed as being automated, the present invention also contemplates that certain steps of the present invention may be completed manually. For example, steps E28, E36, and E44 are indicated as being desirably performed automatically through operation of the control system, its software, and the automated components of the system. The present invention contemplates that steps E28, E36, and B44 may alternatively be performed by the operator by actuating components located outside of the shielded container of the system. For example, steps E28 and E36 may be performed by an operator manually pulling or raising an elongate piston rod which engages the syringe piston and extends through the top of the shielded system container. This piston rod is desirably formed from a radiation shielding material such as lead. Similarly, step E44 may be performed by the operator manually locking out or preventing movement of the syringe piston by locking the above-identified piston rod in place. The present invention further contemplates that step E26 may be performed manually by the operator via use of a manually engageable linkage which can cause the lifting of the vial holder or the lowering of the syringe so that the syringe needle extends through the vial septum in accordance with the present invention.

Moreover, the present invention contemplates that the withdrawal and dispense system of the present invention may include sensors which detect whether the system drawer and door are in an open or closed position. The system also includes a sensor which cooperates with the vial or the vial holder to both determine the type of vial, ie, an eluate vial or a cold kit vial, have been placed in the system and whether the vial holder has been properly positioned within the system to allow eluate transfer to proceed. While the present invention has disclosed a detection system employing a projecting lug on the vial holder which is detectable by a sensor within the system, other types of identification methods, such as bar codes, radio-frequency identification are also contemplated by the present invention. Additionally, a sensor is desirably employed to ensure that the eluate vial holder has been properly raised so that the syringe needle tip is placed therein so as to extend to its lowest portion.

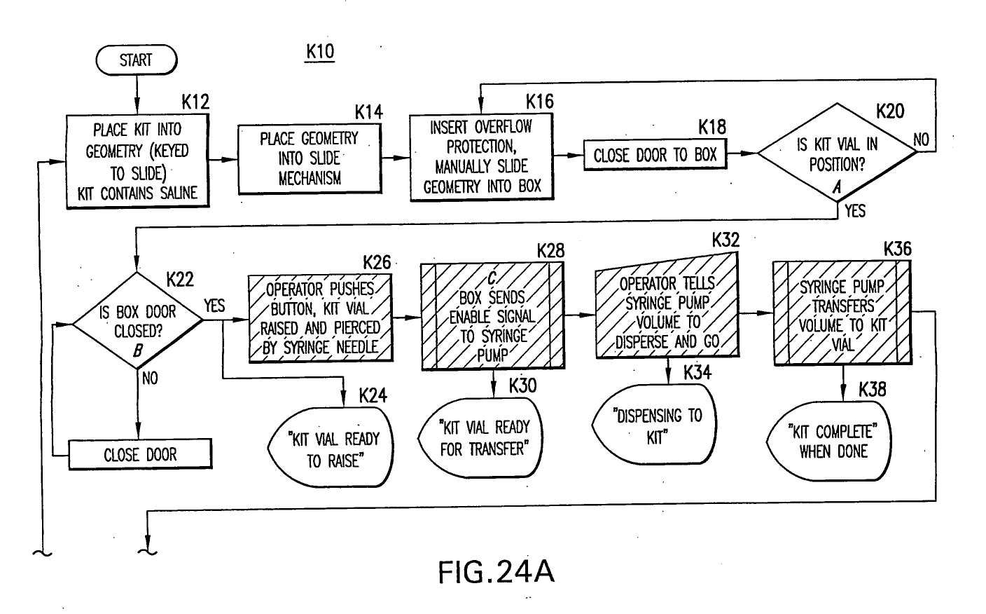

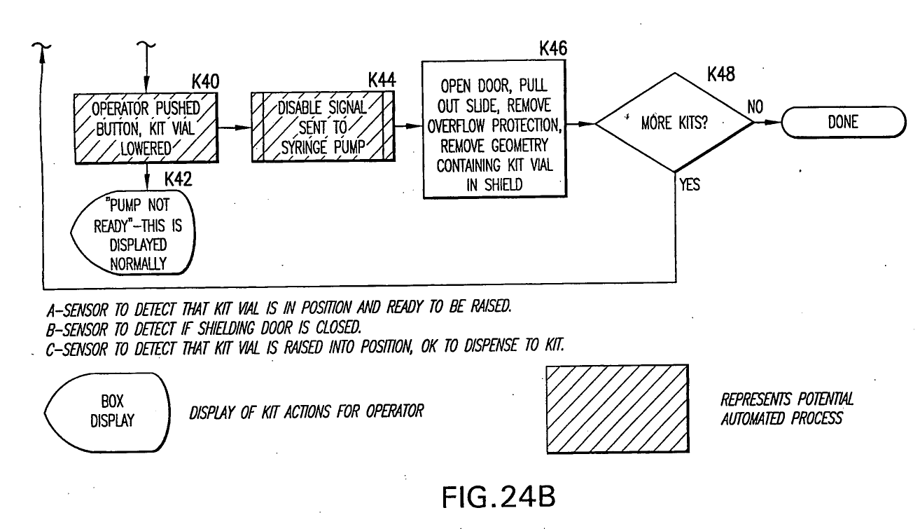

The method K10 of preparing a radioactive kit of the present invention is provided in FIGS. 24A-B and described as follows. In a first step, K12, an operator places a kit vial, the vial itself within a shielded container, into a vial holder. Desirably, the kit vial contains other non-radioactive ingredients which are used to form the final radiopharmaceutical, including saline. The operator also removes the vent needle from its holster mounted in the sliding drawer and inserts it through the vent needle aperture in the vial holder so as to pierce the septum. It is again contemplated by the present invention that the vent needle may itself be positioned at one end of a suitable conduit which is able to contain any leakage of eluate should the eluate flow therethrough, e.g., in the event of overflow from the kit vial during eluate dispensement. The vent conduit may further be connected to a vacuum device for drawing any fluid from the kit vial away from the vent needle or otherwise prevent the kit vial fluid from spilling out of the vent needle upon its withdrawal from the kit vial. In step K14 the operator places the vial holder into the sliding drawer of the filling and dispense system.

In step K16 the operator manually slides the drawer into a closed position, thereby placing the kit vial under the syringe needle. In step K18 the operator closes the door to the filling and dispense system. In step K20 the system desirably checks to ensure that the kit vial is in position by detecting a device or signal unique to the vial holder for a kit vial. If the system fails to detect that a kit vial or vial holder is in the proper position, the operator will be notified. The operator may then access the drawer holding the kit vial and ensure the vial holder is properly placed therein and repeat from step K16 to ensure the drawer is properly closed so that the vial is properly positioned within the system. In step K22 the system will also ensure that the door to the system is properly closed and signal the operator if is not so.

Once the door is properly closed, in step K24 the control system will indicate to the operator that the kit vial is ready to raise. In step K26 the operator pushes the appropriate button (desirably through a graphic user interface display of the control system) to cause the system to cause the syringe needle of the system to pierce through the septum of the kit vial. Desirably, the syringe needle for this operation only pierces the septum a sufficient distance so that the needle tip is just inside the kit vial chamber, typically no more than about 0.25 inches past the septum. Desirably, the method of the present invention causes the piercing of the vial septum by raising the kit vial holder towards the syringe needle, although the present invention contemplates that the syringe of the system is itself movably mounted to linearly extend through the vial septum in a similar manner as previously described for kit preparation system 10.

When the system detects that the syringe needle is properly positioned with respect to the kit vial from step K26, the system in step K28 will enable the syringe pump and in step K30 indicate to the operator that the kit vial is ready to receive the fluid transfer. In step K32 the operator will push the appropriate control system button, either hardwired or a soft switch provided by a graphical user interface, to commence fluid transfer from the syringe barrel to the kit vial. The system will, in step K34, indicate to the operator that kit fill transfer is taking place. As identified in step K36, this operator action will cause the syringe piston to be extended towards the syringe needle, thereby dispensing the eluate from syringe barrel into the kit vial. The requested volume of fluid will be transferred into the kit. Although the fluid is volumetrically dispensed, the completed kit consists of saline and ^{99m}Tc added to a kit to produce a finished volume at a reference, i.e. 50 mCi/mL for a total kit volume of 10 mL (with a total activity of 500 mCi). The control system will then signal to the operator, in step K38, when the fill transfer is complete. In step K40 the operator will then push the appropriate button to cause the separation of the syringe needle from the vial, again by lowering the vial holder, raising the needle, or some combination thereof. In step K42, the control system will display that the pump is not ready, indicating that separation from the needle and vial was attained. Desirably, an appropriate signal is sent to the syringe pump in step K44 to prevent additional withdrawal or dispensement by the syringe. In step K46 the operator would open the system door, pull out the drawer, and remove the eluate vial holder. In step K48 the system would ask the operator whether additional eluate will be transferred into additional kit vials. If so, the operator would then repeat this process from step K12 until the radioactive eluate has been loaded into the desired number of kit vials or the eluate supply in the syringe barrel has been depleted.

While certain steps of the present invention have been discussed as being automated, the present invention also contemplates that certain steps of the present invention may be completed manually. For example, steps K28, K36, and K44 are indicated as being desirably performed automatically through operation of the control system, its software, and the automated components of the system. The present invention contemplates that steps K28, K36, and K44 may alternatively be performed by the operator by actuating components located outside of the shielded container of the system. For example, steps K28 and K36 may be performed by an operator manually pulling or raising an elongate piston rod which engages the syringe piston and extends through the top of the shielded system container. This piston rod is desirably formed from a radiation shielding material such as lead. Similarly, step K44 may be performed by the operator manually locking out or preventing movement of the syringe piston by locking the above-identified piston rod in place. The present invention further contemplates that step K26 may be performed manually by the operator via use of a manually engageable linkage which can cause the lifting of the vial holder or the lowering of the syringe so that the syringe needle extends through the vial septum in accordance with the present invention.

Moreover, the present invention contemplates that the withdrawal and dispense system of the present invention may include sensors which detect whether the system drawer and door are in an open or closed position. As discussed hereinabove, the system also includes a sensor which cooperates with the vial or the vial holder to both determine the type of vial, ie, an eluate vial or a cold kit vial, have been placed in the system and whether the vial holder has been properly positioned within the system to allow kit fill transfer to proceed. While the present invention has disclosed a detection system employing a projecting lug on the vial holder which is detectable by a sensor within the system, other types of identification methods, such as bar codes, radio-frequency identification are also contemplated by the present invention. Additionally, a sensor is desirably employed to ensure that the kit vial holder has been properly raised so that the syringe needle tip is placed therein so as to extend just past the vial septum.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

1. A kit preparation system comprising:
a housing defining a preparation cavity, said housing formed from a radiation-shielding material;
a syringe comprising an elongate hollow needle connected to a hollow syringe barrel supporting a slideable syringe piston therein;
a syringe actuator for extending and retracting said syringe piston;
a vial holder for holding the pierceable septum for a vial in registry with the needle tip of said syringe;
a translational mechanism for extending the needle tip through the septum of the vial.

2-18. (canceled)

19. A cradle for holding a vial containing contents to be withdrawn, said cradle comprising:
a cradle base;
at least one upstanding wall supported on said cradle base;
a vial retention mechanism defining a vial cavity for accepting a vial, said retention mechanism releasably engaging a vial in said vial cavity; and
a crownpiece supported by said at least one upstanding wall to extend over said vial cavity, said crownpiece defining a first aperture therethrough in overlying registry with said vial cavity

20. A cradle of claim 19, wherein said crownpiece further defines a second aperture therethrough, said second aperture opening in registry with said vial cavity, wherein said first and second aperture are sized to accommodate an elongate hollow needle therethrough and extend along a first and second axis, respectively, and wherein said first and second axis are non-parallel.

21. (canceled)

22. (canceled)

23. A cradle of claim 19, further comprising an identification means detectable by a detector of a fluid transfer system.

24. A cradle of claim 23, wherein said identification means comprises a lug projecting from said cradle.

25. A cradle of claim 19, wherein said retention mechanism maintains a vial inserted into said vial cavity at a tilted orientation to normal.

26. A cradle of claim 19, wherein said base includes a sloped upper surface for supporting a vial inserted into said vial cavity.

27. A cradle of claim 25, wherein said cradle holds a vial inserted in said vial cavity such that the lowest point of the interior of the vial is positioned in underlying registry with one of said apertures of said crownpiece.

28. A cradle of claim 19, wherein said retention mechanism further comprises a first and second elongate arm supported about said vial cavity.

29. A cradle of claim 19, wherein at least one of said first and second arms is deflectably mounted to allow a vial to pass therebetween into said vial cavity.

30. A cradle of claim 28, wherein at least one of said first and second arms supports a transversely-extending detent adjacent a free end thereof for retaining a vial in the vial cavity.

31. (canceled)

32. A cradle of claim 30, wherein said detents define opposing tapered front surface leading towards said vial cavity.

33. A method of withdrawing the contents from a vial with an automated fluid transfer device, wherein said vial defines an interior chamber and includes a planar base, an upstanding cylindrical wall and a pierceable septum about said interior chamber, and wherein said transfer device includes an elongate syringe supporting an elongate needle wherein said syringe and vial are linearly moveable with respect to each other so as to allow said needle to pierce a septum of said vial, comprising the step of:
placing the vial into a vial holder which holds the vial in a slanted geometry with respect to the needle so that the needle may reach the lowest portion of said vial chamber as defined between the planar base and cylindrical wall.

34. A method of claim 33, further comprising the steps of:
placing the vial holder into a sliding door assembly; and
closing the sliding drawer so as to position the vial septum in underlying registry with the needle of the syringe;
extending the needle into the vial chamber to the lowest portion of the vial chamber;
selecting an amount of fluid to withdraw from the vial chamber; and
effecting transfer of the selected amount of fluid from the vial chamber into the syringe;

35. A method of claim 34, further comprising the step of:
independently verifying that the vial is located in the correct position under the needle.

36. (canceled)

37. (canceled)

38. (canceled)

39. A method of claim 38, further comprising the steps of:
separating the vial from the needle;
opening the drawer to expose the vial holder to the operator; and
removing the vial from vial holder.

40. A method of claim 33, further comprising the step of:
inserting the tip of an elongate vent needle through the vial holder into the vial chamber.

41. (canceled)

42. A method of dispensing the contents of a syringe in an automated dispense system into a kit vial, wherein the kit vial defines an interior chamber and includes a planar base, an upstanding cylindrical wall and a pierceable septum about the interior chamber, and wherein the transfer device includes an elongate syringe supporting an elongate needle wherein the syringe and vial are linearly moveable with respect to each other so as to allow the needle to pierce a septum of the vial, comprising the steps of:
Placing the vial, within its shield, into a vial holder; and
Inserting the tip of an elongate overflow needle through the vial holder into the vial chamber.

43. A method of claim 42, further comprising the steps of:
placing vial holder into a sliding door assembly;
closing the sliding drawer so as to position the vial septum in underlying registry with the needle of the syringe;
independently verifying that the vial is located in the correct position under the needle;
inserting the tip of the needle of the syringe through the septum and into the vial chamber; and
dispensing a predetermined amount of fluid into the vial chamber;

44. (canceled)

45. (canceled)

46. A method of claim 45, further comprising the steps of:
removing the tip of the needle from the vial chamber; and
opening the drawer so as to expose the vial holder to an operator;
removing the overflow needle from the vial; and
removing the vial from the vial holder.

47. (canceled)
